(19) United States
(12) Patent Application Publication
(10) Pub. No.: US 2005/0231689 A1
(43) Pub. Date: Oct. 20, 2005

(54) Economical camera-support-and-movement track-and-dolly system providing high stability and precision to camera movement

(76) Inventor: Brian Longley, Grants Pass, OR (US)

Correspondence Address: William C. Fuess;FUESS & DAVIDENAS, Suite II-G, 10951 Sorrento Valley Road, San Diego, CA, 92121, US

(21) Appl. No.: 10/825,753

(22) Filed: Apr. 16, 2004

(51) Int. Cl. B62B 3/00; G03B 21/00

(52) U.S. Cl. 352/243; 396/419

(57) ABSTRACT

A system for moving a camera in space has a track with two spaced-parallel rails, each rail having two upward-extending spaced-parallel lips, and a dolly holding the camera and riding upon both rails of the track. The track is preferably segmented with each elongate rail segment preferably in the cross-section of half of a tube, while the dolly has wheels that contact only, and that ride upon, the upward-extending spaced-parallel lips of each half-tubular rail. The camera is mounted close upon the support platform of the generally rectangular wheeled dolly, which is itself squat and low to the track's two spaced-parallel rails. According to the geometries of construction, the camera is relatively insensitive in space and in angular orientation to such irregularities in track and moving dolly as are in any case minor by design, and the camera can be moved along complex paths with great precision for purposes of motion pictures and movies.

### BACKGROUND OF THE INVENTION

1. Field of the Invention

The present invention generally concerns systems and methods for moving a camera in both space and angular orientation, as during the creation of motion pictures or videos

The present invention particularly concerns construction of a track, and also a wheeled dolly that both rides upon the track and mounts a camera, so that both spatial and angular irregularities and errors both in the track and in the motion of the wheeled dolly are minor, and so that such irregularities and errors as are uneliminatable are not magnified in the spatial or angular orientation of the camera, which camera can be economically controlled to move with considerable stability and precision.

2. Description of the Prior Art

The camera movement system of the present invention is related to camera car rigs, jib arms, dollies, dolly track, dolly spreaders, heads, tripods, and pedestals.

These items of the prior art serve, when configured in manners most applicable to the present invention, to move a camera that is mounted upon a tall, multi-foot, pedestal or tripod along a base, or track. It will seen to be advanced in the present invention that the considerable distance of the moment arm of the camera from the base or track upon which it rolls magnifies unavoidable errors in the any of the position, level, flatness and/or angular orientation or said base or track, and makes that the camera movement systems are most typically large, massive and expensive. As cameras are reduced in volume and weight, the utility and cost-effectiveness of massive “studio-type” camera movement systems is questionable, and the present invention will be seen to address precision camera movement from first principles of mechanics.

As an example of the state of the prior art circa 200, the robotic studio equipments of the Vinten AutoCam™ system are typical. See Vinten Broadcast Ltd., Western Way, Bury St Edmunds, Suffolk IP33 3TB, UK. Comprising pan and tilt heads, pedestals and control systems of various types, the AutoCam system is advanced for use by small studios, fully robotic studios, outside broadcast and legislative applications.

The AutoCam pan and tilt heads range from the lightweight to the heavyweight heads designed to support large studio cameras together with any combination of lens, viewfinder or teleprompter up to a maximum payload of 90 kg (200 lbs). Robotic pedestals are available in servo/manual hybrid form, with robotic movement only in the ‘Z’ or height axis, or in fully robotic ‘X/Y/Z’ form. Control motion control systems are available at varying degrees of complexity ranging up to a sophisticated touch screen technology. All AutoCam™ mechanical, electromechanical and electronic sub-systems are designed for very low maintenance and maximum reliability.

Yet another prior art system is the StarTrack™ dolly track of the Matthews company. See Matthews Studio Equipment, Inc., 2405 W Empire Avenue, Burbank, Calif. 91504 U.S.A. Matthews advances its system as the epitome of design and manufacturing of precision dolly track. Both heavy Wall and stainless steel dolly track is available. Heavy wall is manufactured from 1½″ diameter steel and is chrome plated to protect it from negative environmental effects. It is slightly less expensive than stainless steel track. Stainless steel track does not require plating. Due to the inherent characteristics of the material, it is impervious to the elements. However, Matthews does not recommend that the two types of track be used together. The chrome plating used on the Heavy Wall can create size buildup and the finished diameter may be slightly larger. This can create a noticeable “bump” at the joint.

The Matthews curved tracks are available to complete 10′, 20′ and 70′ diameter circles. However, most dollies will not navigate the 10′ circle without the addition of a multi wheeled device such as the Matthews “Centipede”. Four pieces of 90° curved track are needed to complete a circle. Eight pieces are required for 20′ diameter and 16 pieces for the 70′ diameter circle.

All Matthews Dolly Track is rated to a maximum payload of 1200 lbs. (545 kg.) at the industry standard of 24.5 center to center track width.

Before entering into the teaching of the present invention, it should be noted that neither the camera movement system of the present invention, nor the comparable systems of the prior art, either preclude, or are obviated by, the optical or digital image stabilization now available on most digital video camcorders. Optical stabilization uses a series of lenses to reduce camera movement, while digital image stabilization uses digital technology to correct imperfections, or “jitter” in movement. However, corrections cannot account for path deviations. When a camera is moved it is desired to move it along a predetermined path with great precision. In the past this has been realized with heavy tripod and tracks or similar support mechanisms to help keep a moving camera stable. The present invention will be seen to function somewhat differently, and to substantially rely upon geometry of mechanical design as opposed to weight and mass in order to impart stability to a camera in motion.

Camera stabilization is must for anyone shooting anything professionally. Although some have suggested that the “shaky cam” look is artistic, for most people it gets annoying after a short while. Stability is the key. Mechanical supplemental stabilization systems such as those from Glidecam have gained acceptance in filmmaking, particularly in films shot on digital video. One of the things that continues to distinguish a professional movie or video “shoot” from that of a rank amateur is the amount of “shake” in a camera. Professionals normally don't like any kind of shakiness to a camera unless that's their style or they're filming an earthquake scene. This is where the Glidecam system comes in, achieving stability by using a gimbaled handle to isolate a counterbalanced camcorder from the operator. It is touted to work well with camcorders weighing up to 5.5 pounds, and is easy to assemble, balance and use. The camcorder is secured to a plate that rests atop a 16 inch aluminum rod. Depending upon the camcorder, up to two pounds of washers is to the bottom of the rod for balance. With a camcorder. The Glidecam's total weight ranges from about six to ten pounds.

Still other, larger devices, called “stabilizer sleds” are in use at major motion picture studios. The present invention will be seen to be directed to realizing stability and precision in camera movement without expensive, or add-on corrective, stability systems.

### SUMMARY OF THE INVENTION

The present invention contemplates a camera support and movement track and dolly system that, nonetheless to being economical of construction and easy to use, accords high stability, and precise spatial movement, to a mounted camera of any type.

The system of the invention so functions because a (1) very squat, and compact, camera dolly precisely stably rests upon, and follows along, a (2) modular track that is itself easily and accurately positioned and affixed over any terrain or structure with both high positional accuracy and stability. Both the (1) dolly and the (2) track so function not because of any special materials or tolerances of construction, but rather because of careful attention to simple rules of mechanics.

Namely, (1) the track is of a regular and excellent contour, (2) the camera dolly conforms very tightly, smoothly and precisely to the track in its spatial movements, while (3) the camera, rigidly affixed to the dolly, is located at a very short moment arm to the track. This (3) short moment arm, in particular, makes that such irregularities and imperfections in movement as the (2) camera dolly inevitably undergoes during its movement along the (1) track—which irregularities and imperfections are normally of the order of fractions of centimeters and/or angular degrees—are not magnified—as is common in the prior art—in the movement of the camera.

Furthermore, the (1) track is very accurately and stably spatially and angularly positioned so as to ultimately support any desired camera shot(s) by the optional use of such simple geometric aids as a straight edge, a carpenter's level, and/or a piece of string for setting any radius of curvature. The (1) track is modular in construction, with segments that join seamlessly and without any substantial irregularities in position, surface contour, or direction (in either azimuth or elevation).

Thus, in accordance with the present invention, when the (1) track is very accurately and stably positioned, and when the camera is fixedly mounted to the (2) camera dolly that rides precisely and smoothly upon this track, then the only parameters of camera motion remaining are camera velocity and, optionally, camera acceleration. In accordance with the present invention, the rolling friction between the (1) track and the (2) camera dolly—which is relatively lightweight—is low, and the camera dolly may quite readily be pushed or pulled along the track, or can be driven by a motor, or can even be accelerated in motion as by benefit of the impulse derived from a falling weight—all with but minimal force and difficulty.

Overall in accordance with the present invention it is generally possible for an amateur to control the both the complex motion and the stability of a camera in each of space, angular orientation and time—even as such camera may be used for motion picture or video shots that are prolonged in duration and/or extensive in space—with substantially the same results, and with potentially less effort, as is normally obtained by the use of a complex, heavy and expensive studio camera motion system.

The camera motion system of the present invention is durable, light weight, and easy to erect, disassemble, move and store. It is modular in construction, and extendable (or repairable) by addition (or substitution) of, most normally, added or different sections of straight and/or curved track. The system of the present invention is not limited to supporting the movement of motion picture and/or video cameras, nor cameras in general, but will alternatively serve to precisely move many things, including instrumentation packages and even a human adult, in space, in angular orientation, and in time.

1. A System for Moving a Camera in Space

In one of its aspects the present invention is embodied in a system for moving a camera in space. The system includes (1) a track having two spaced-parallel rails each rail having two upward-extending spaced-parallel lips, and (2) a dolly, or cart, holding the camera and riding upon both rails of the track. This dolly has wheels that contact only, and that ride upon, the upward-extending spaced-parallel lips of the rails. So supported, the dolly may be considered “self centering” to the rails, and will, in accordance with the narrow rail lips upon which it is supported, ride the rails with millimeter precision.

Each rail of the track preferably consists of a substantially planar elongate element shaped in the substantial contour of an external surface of one-half of an elongate prism, where opposite side edges of the element transverse to its elongate axis constituting the upward-extending spaced-parallel lips. The element is most preferably in the prismatic shape of one-half of a cylinder, or tube. Namely, the track's rail's element is in the form of one-half of a upturned tube, exposed lips and trough of the tube positioned upward. (This tube is, of course, a substantially planar elongate sheet shaped in the substantial contour of the external surface of one-half of an elongate cylinder.) The track's rail's element is still more preferably a split aluminum tube.

The dolly's wheels are preferably of elastomeric compound, with each wheel spanning, and riding upon, an opposite two side edges of the track's rail's element upon which, and by which, it is supported.

The track itself preferably consists of track segments pieced together so that two upward-extending spaced-parallel lips of one segment abut tightly and contiguously to two upward-extending spaced-parallel lips of another segment. By this construction there is no appreciable crack nor any discontinuity in line and in level between the abutting lips of successive segments.

This union of track segments is preferably realized by connection members extending between, piecing together, and connecting adjacent track segments at, and between, a downward-extending region of each segment and of the track. So positioned these connection members not extending into the region of the upward-extending spaced-parallel lips of the segments and of the track, and do not interfere with the wheels or the movement of the dolly.

In the system at least one spaced-parallel pair of the track segments is commonly straight, and often one or more spaced-parallel pair of the track segments will be curved. Indeed, successive track segments may collectively form an arc of a circle, or even a full circle.

In the most preferred system the track is supportable for use so low as six inches above the earth, or greater to such heights, normally of many meters, as the track may be reliably and safely supported, as upon scaffolding.

In the most preferred system a center of gravity of the camera is within six inches of an imaginary plane between the lips of the two rails of the track. By this short moment arm between the camera and either rail of the track, any sway in elevation angle of the camera during spatial movement of the camera along the track is reduced.

The dolly preferably includes a stanchion upon which is variably mounted and secured the camera so that a center of gravity of the camera is situated midway between the two spaced-parallel rails of the track. The dolly may optionally include a motor which drives the dolly along the track by turning its wheels.

2. A System for Moving a Camera in Space Along a Straight Line at Fixedly Predetermined Elevational and Azimuthal Angles

In another of its aspects the present invention is embodied in a system for moving a camera in space along a straight line at fixedly predetermined elevational and azimuthal angles relative this straight line. During all conditions of use this camera movement system has rails that are straight to better than plus or minus one degree. A number of members positioned between the rails of the track along an imaginary Y axis hold the straight rails (i) at less than one percent deviation in distance of separation in the Y axis direction everywhere so that, at this distance of separation, (ii) the rails are everywhere spaced-parallel to within one degree.

A mechanism for adjusting the height above the surface of the earth of the track and its rails along an imaginary Z axis makes that a plane of the rails is everywhere level to within one degree.

Finally, a dolly has wheels that are both (i) fixed in separation at better than one percent accuracy wheel-to-wheel measured along the imaginary Y axis direction transversely across the track, and (ii) of the same height to better than one percent, of both wheel-to-wheel separation and height. The dolly with such equal-height wheels will ride level within one degree of angle upon the evenly-spaced-parallel rails of the level track.

The dolly mounts a camera at a fixedly predetermined position (1) having less than one percent deviation in each of positions relative to the dolly along the imaginary X and Y axis directions, (2) at an elevation constant to within one percent along the imaginary Z axis direction, and (3) with less than one degree variation in azimuthal and in elevational angles relative to the dolly.

Now none of these parameters of construction are extraordinary. Although the above express limitations are definitive, all that is effectively set forth is that the track, and the dolly, are reasonably mechanically precise, and are precisely positionable relative to the earth and to each other. To some degree any quality camera positioning system might be expected to be possessed of some of these properties, although (1) the level positioning of the track, and (2) the spaced-parallel positioning of the track rails, so as to both be within one degree of tolerance might be considered challenging, especially in a low-cost system.

However, in accordance with the present invention, the dolly so mounts the camera at a moment arm in elevation relative to the track which moment arm is short. The moment arm is so short that any variations relative to level of the dolly—which variations are themselves relative to any variation in level of the plane of the rails—produce less than one degree variation in both elevational and azimuthal angles of the camera relative to the straight line of the track. In simple terms, the camera is mounted very low upon a dolly that is itself low and squat to the track. In the first place this means that images that are at a very low level, and scarcely elevated above, the track may readily be derived. However, more importantly for the camera stability aspects of the present invention, no such magnification of camera angle error in elevation, or in azimuth, occurs as would be the case should the camera be mounted upon a high pedestal, or tripod—as is normal in the prior art. Instead, any errors in camera elevation angle as arise from errors (or vibrations) in the “Y”, or track transverse, axial direction, and/or any errors in camera azimuthal angle as arise from errors (or vibrations) in the “X” axil direction, or longitudinally along the track, are both minimized by the short moment arm of the camera mount.

In this embodiment of the invention, as before, the track preferably consists of two spaced-parallel rails each rail having two upward-extending spaced-parallel lips. The wheels of the dolly then contact, and ride upon, only these upward-extending spaced-parallel lips of the rails.

More particularly, each rail of the track is preferably a substantially planar elongate element shaped in the substantial contour of an external surface of one-half of an elongate prism, with opposite side edges of the element transverse to its elongate axis constituting the upward-extending spaced-parallel lips. This elongate element is still more preferably one-half of a tube, which tube is, or course, a substantially planar elongate sheet shaped in the substantial contour of the external surface of one-half of an elongate cylinder. The tube is most preferably made of aluminum tube, and is normally made by longitudinally splitting a standard thin-wall tube.

Also as before, the wheels of the dolly are preferably made of an elastomeric compound of size and contour so as to span, and to ride upon, opposite side edges of the element. These wheels may optionally be driven by an optional motor upon the dolly.

The track is preferably segmented, with the track segments pieced together so that there is no appreciable crack nor any discontinuity in line and in level between abutting lips of successive segments.

3. A Method of Moving a Camera in Space

In yet another of its aspects the present invention is embodied in a method of moving a camera in space.

The method starts with adjusting level above the surface of the earth a track having two spaced-parallel rails each rail having two upward-extending spaced-parallel lips. A camera is mounted to a dolly riding upon both rails of the track, the dolly having wheels that contact only, and that ride upon, the upward-extending spaced-parallel lips of the rails.

In the method the track is preferably segmented for transport and storage, while in use (for moving the camera in space) the track segments are pieced together so that two upward-extending spaced-parallel lips of one segment abut tightly and continuously to two upward-extending spaced-parallel lips of another segment. There is thus no appreciable crack nor any discontinuity in line and in level between abutting lips of successive segments.

This piecing together of the track segments preferably consists of connecting track segments with and by members extending between, and connecting, adjacent track segments at, and between, a downward-extending region of each segment and of the track. By this construction and this piecing together these connection members do not extend into the region of the upward-extending spaced-parallel lips of the segments and of the track.

The method preferably still further includes locating a center of gravity of the camera to be within six inches of a plane between the lips of the two rails of the track. By this construction, and this locating, any sway in elevation angle of the camera during spatial movement of the camera along the track is reduced in accordance that a moment arm of the camera about either rail of the track is short.

The adjusting level of the track above the surface of the earth preferably consists of adjusting the extension(s) of a multiplicity of variably extending stanchions upon which supported the track above the surface of the earth.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a diagrammatic perspective view showing a preferred embodiment of a camera support and movement track and dolly system in accordance with the present invention.

FIG. 2 is a detail perspective view of the track within the preferred embodiment of a camera support and movement track and dolly system in accordance with the present invention previously seen in FIG. 1.

FIG. 3 is a detail plan view of the dolly within the preferred embodiment of a camera support and movement track and dolly system in accordance with the present invention previously seen in FIG. 1.

FIG. 4 is a detail perspective view of the dolly previously seen in FIGS. 1 and 3, now with optional motors.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

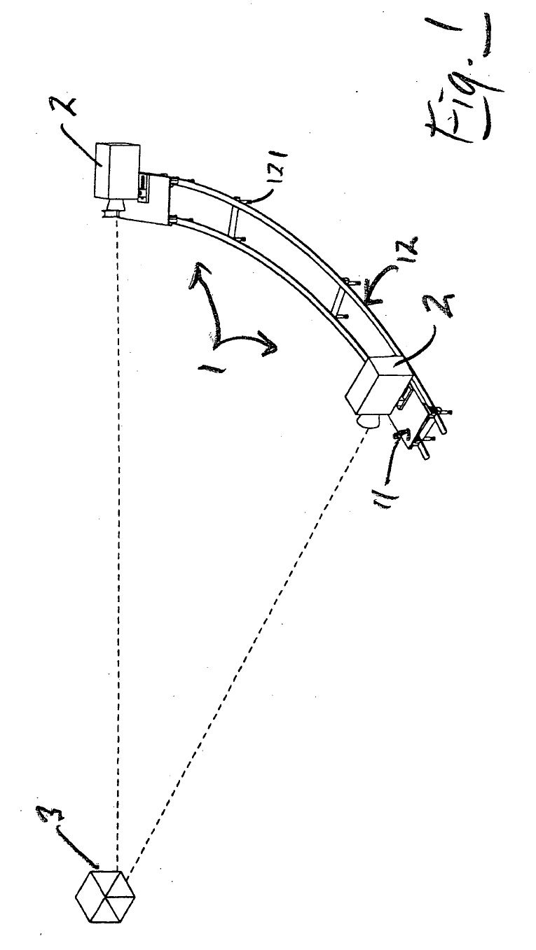

A preferred embodiment of a camera support and movement track and dolly system 1 in accordance with the present invention is shown in diagrammatic perspective view in FIG. 1. A camera 2 (shown in phantom line for not being part of the present invention) is affixed to ride upon a wheeled dolly 11 that itself rides upon a track 11. The dolly 11 and camera 2 are shown in two displaced, alternative, positions. (Alternatively, it is possible to place more than one dolly 11 and camera 2 upon the track 12 at the same time, and FIG. 1 may equally well be considered to show this condition.)

The track 12 is shown to be curved, and curved at a uniform radius, as in the arc of a circle. In the case of FIG. 1, the camera 2 shoots to the same imaginary focal point 3, as illustrated, in both positions along the curved track 12.

This condition need not be the case, as the track 1 can be (1) straight, and/or (2) curved, including at different (2a) radius and (2b) orientation of concave or convex orientation, in whole or in part, or both (1) straight and (2) curved in different parts. In general the track 12 is erected upon its adjustable-height stanchions 121 along a route, and along a three dimensional path, where the camera 2, normally of a motion picture or video type, is desired to be moved, as during the shooting of a scene.

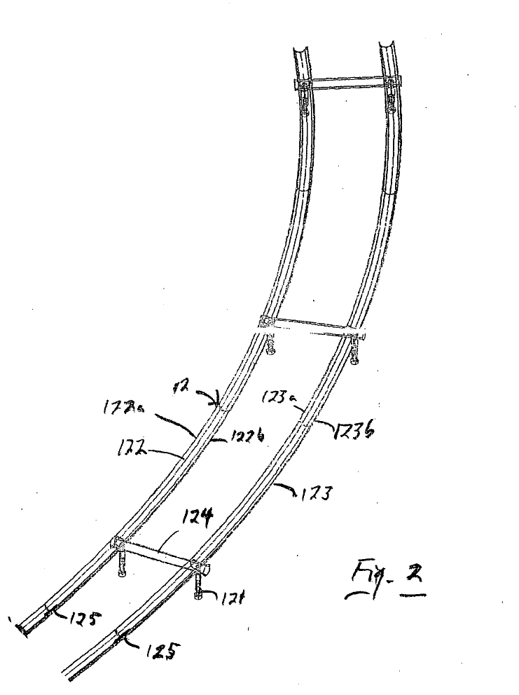

The preferred embodiment of the track 12 is shown in detail perspective view in FIG. 2. Each rail 122, 123 of the track is preferably in the substantial contour of the external surface of one-half of an elongate prism. This external surface of the (one-half, elongate) prism does not extend forever, and where terminating can be called an “edge”. For example, the external surface of an elongate prism having a triangular cross section is itself in the shape of a hollow triangle, and the external surface of one half of this elongate triangular prism split longitudinally would be in the shape of a “V”. The termination of the two “legs” of the “V” can be called edges, and can be oriented so as to extend upwards. Each rail 122, 123 has two opposite side edges in a direction transverse to its elongate axis, and this pair of side edges constitutes upward-extending spaced-parallel lips 122a, 122b and 1223a, 123b.

The track rails 122, 123 are more preferably in the shape of one-half of a hollow tube slit longitudinally, as illustrated. One geometric description such a hollow tube is of, of course, that it is a substantially planar elongate sheet shaped in the substantial contour of the external surface of one-half of an elongate cylinder.

The most preferred tubes of the track rails 122, 123 are made from split aluminum tubing, preferably type of size 1/2 inch diameter available from standard industry sources. Tubing of greater, or lessor, strength and diameter can be used depending upon the weight of the camera and camera dolly, the span of unsupported segments, etc.

The track rails 122, 123 are supported by pairs of stanchions 121 which are spaced apart by cross-members 124. The stanchions 121 may rest upon the earth ground, or any surface—not necessarily flat—such as a building. The stanchions 121 are preferably adjustable in extend by a simple screw post mechanism, permitting the track to be adjusted in each of height (elevation) and angle substantially throughout its extent.

The track 11 is preferably sectioned, normally in sections that are, most typically some few feet in length. Each track segment is typically semi-permanently firmly tied to the next by a simple adjustable metal connection member, or strap, or strut 125 extending between, piecing together, and connecting the adjacent track segments. These members 125 are located at a downward-extending region of each track segment and of the overall track 11. These members 125 do not extend into the region of the track 12's upward-extending spaced-parallel lips 122a, 122b and 123a, 123b. Accordingly, they do not interfere with rolling movement of the trolley 11 upon the track 12, as will be next explained. The track segments are pieced together by the connection members 125 so that two upward-extending spaced-parallel lips 122a, 122b or 123a, 123b of one track segment abut tightly and contiguously to a corresponding two upward-extending spaced-parallel lips 122a, 122b or 123a, 123b of another track segment, there being no appreciable crack nor any discontinuity in line and in level between abutting lips of successive segments of the track 12.

The track is preferably supported so as to be adjustable in height upon support post 121 (previously seen in FIGS. 1 and 2). These posts 121 are preferably constructed as a screw post that variably screws into an internally threaded bore of a cylinder.

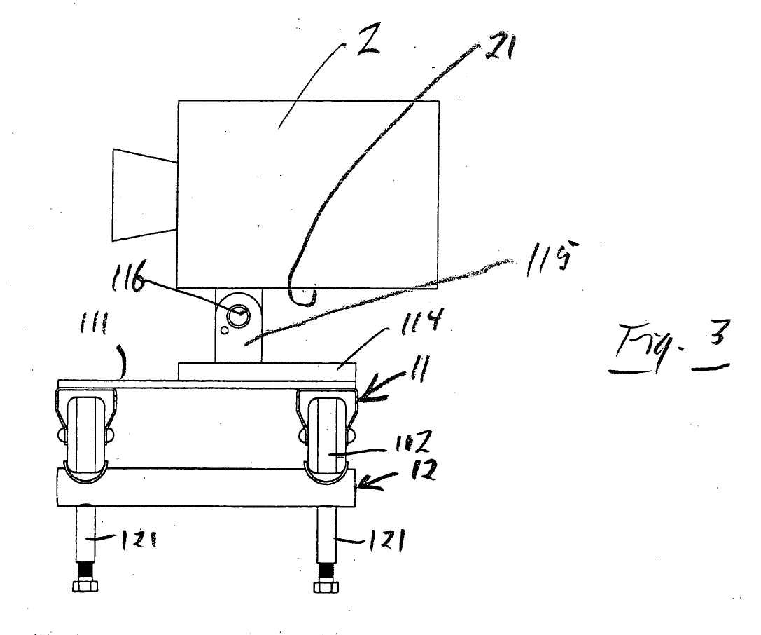

The dolly 11 within the preferred embodiment of a camera support and movement track and dolly system 1 in accordance with the present invention (previously seen in FIG. 1) is shown in detail perspective view in FIG. 3. The dolly 11 has a central rigid frame 111 that is most normally made of metal or fiberglass or a like rigid material. The underside of the frame 111 rigidly and fixedly mounts with geometric precision and precise separation four wheels 112. Pairs of the wheels 112 as are opposite transversely across the track 11 (in imaginary “Y” axis direction) are separated so as to precisely engage opposite pairs the upward-extending lips 122a, 122b or 123a, 123b of the track 11 as these track rails, and these lips, are held in precision separation by the cross-members 124.

Moreover, and importantly, the wheels 112 are too large so as to fit within exposed, upward-oriented, and concave central cavity of the elongate track 11 which, as previously explained, is preferably made from longitudinally split metal, and most preferably aluminum, tube. Accordingly, the wheels 112 ride upon the upward-extending lips 122a, 122b or 123a, 123b of the trails of the track 11. This causes that the wheels 112, and the entire dolly 12, is self-centering to the track 11 upon which it rolls, and—in accordance that the track 11 is of regular, contiguous and precise geometry—will roll on the track 11 with minimal vibration or irregularity in the intended three-dimensional spatial and/or omni-angular position of the cart. Simply put, when the track 12 is well and precisely laid—which it readily can be—then the dolly 11 rolls upon the track 12 with spatial and angular precision and exactitude.

The wheels 112 are preferably made of elastomeric compound, further dampening any vibration or other distortion(s) during movement of the dolly 11 along the track 12.

Of course, it is not the precise spatial and angular position of the dolly 11 that is of ultimate interest. Instead, it is the spatial and angular position of the camera 2 (shown in phantom line in FIGS. 1 and 3, and not part of the present invention), that is of ultimate interest. The camera 2 is normally removably, but fixedly and highly accurately, mounted to the dolly 11 by the stanchion including a plate 114 and a pivot joint 115 as shown in FIG. 3. In use of the stanchion including the plate 114 and pivot joint 115 a base 21 of the camera 2 is ultimately connected to the plate 114 at a variable angle determined by pivot joint 115. A selected angular position of the pivot joint 115 is preserved by a threaded thumbscrew 116. The stanchion in all its parts preferably holds the camera 2 (shown in FIG. 1) at less than six inches elevation above the track 12 (shown in FIGS. 1 and 2).

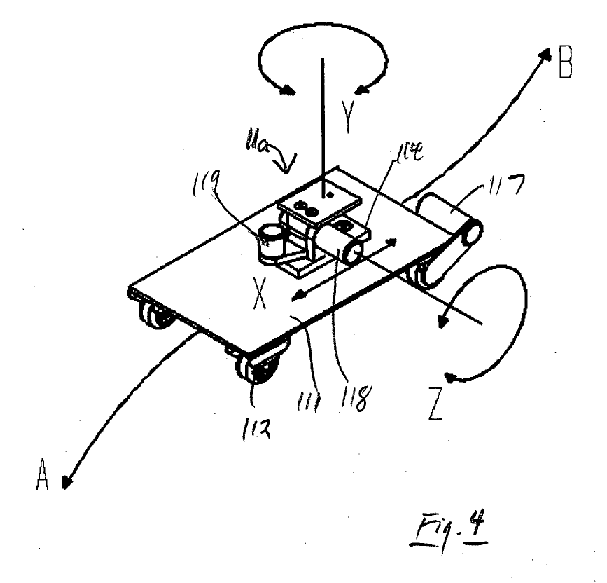

The camera 2 (shown in FIG. 1, not shown in FIG. 4 and not part of the present invention) mounts to the pivoting stanchion by conventional means, normally machine bolts that thread tapped bores, or that pass through holes to be secured by nuts or the like. For quick release purposes bolts that have heads that slip into racetrack-shaped apertures, as are well known in the art, may be used.

The combined stanchion and camera 2 have (1) a center of gravity, and—equivalently because both stanchion 113 and camera 114 are roughly balanced—and also have (2) an axis of rotation about the longitudinal, or “X”, axis of the track 12, that is situated midway between the two spaced-parallel rails of the track 12. See FIG. 4. This means that the “roll axis” of the camera due to any height (or other) irregularity between the two spaced-parallel rails of the track 11 is both midway between these rails, and spaced but slightly (six inches or less) above them. By this construction, and this orientation, the movement in both space and in angle of the camera 2 due to irregularities in the track 11 and in the height of its two spaced-parallel rails is caused to be much less than would be the case, as is normal in the prior art, that the camera 2 was upon a high pedestal, or tall column, above the dolly 11 and the track 12.

A motorized embodiment of the dolly 11 is shown in FIG. 4. A motor 117 acting through a conventional belt or gear drive mechanism turns at least one of the wheels 112, and drives the dolly along the track 12 (seen in FIGS. 1 and 2). A motor 118 serves to adjust the angular orientation, or tilt, of the camera mount and of the camera 2 (shown in FIGS. 1 and 3, not shown in FIG. 4) about the “Z” axis. Similarly, a motor 119 serves, with a proper and conventional adjustment of the pivot axis of the stanchion 115, to adjust the angular orientation, or tilt, of the camera mount and of the camera 2 (shown in FIGS. 1 and 3, not shown in FIG. 4) about the “Y” axis. Still other orientations and movements are possible as are known in the mechanical arts.

In accordance with the preceding explanation, variations and adaptations of the camera-support-and-movement track-and-dolly system in accordance with the present invention will suggest themselves to a practitioner of the mechanical design and engineering arts.

For example, the cross-sectional contour of the track 12 need not be that of a semi-circle, but could alternatively be in the shape of the letters “U”, or “V”, or even “X”.

In accordance with these and other possible variations and adaptations of the present invention, the scope of the invention should be determined in accordance with the following claims, only, and not solely in accordance with that embodiment within which the invention has been taught.

1. A system for moving a camera in space comprising:
a track having two spaced-parallel rails each rail having two upward-extending spaced-parallel lips; and
a dolly holding the camera and riding upon both rails of the track, the dolly having wheels that contact only, and that ride upon, the upward-extending spaced-parallel lips of the rails.

2. The system according to claim 1 wherein each rail of the track comprises:
a substantially planar elongate element shaped in the substantial contour of an external surface of one-half of an elongate prism, with opposite side edges of the element transverse to its elongate axis constituting the upward-extending spaced-parallel lips.

3. The system according to claim 2 wherein the track's rail's element comprises:
one-half of a tube, said tube being a substantially planar elongate sheet shaped in the substantial contour of the external surface of one-half of an elongate cylinder.

4. The system according to claim 3 wherein the track's element comprises:
a split aluminum tube.

5. The system according to claim 3 wherein the dolly's wheels comprise:
wheels of elastomeric compound spanning, and riding upon, opposite side edges of the element.

6. The system according to claim 1 wherein the track comprises:
track segments pieced together so that two upward-extending spaced-parallel lips of one segment abut tightly and contiguously to two upward-extending spaced-parallel lips of another segment, there being no appreciable crack nor any discontinuity in line and in level between abutting lips of successive segments.

7. The system according to claim 6 wherein the track further comprises:
connection members extending between, piecing together, and connecting adjacent track segments at, and between, a downward-extending region of each segment and of the track, these connection members not extending into the region of the upward-extending spaced-parallel lips of the segments and of the track.

8. The system according to claim 6 wherein at least one spaced-parallel pair of the track segments is straight.

9. The system according to claim 6 wherein at least one spaced-parallel pair of the track segments is curved.

10. The system according to claim 6 wherein successive track segments collectively form an arc of a circle.

11. The system according to claim 1 wherein the track is supportable for use so low as six inches above the earth or greater.

12. The system according to claim 1
wherein a center of gravity of the camera is within six inches of an imaginary plane between the lips of the two rails of the track;
wherein any sway in elevation angle of the camera during spatial movement of the camera along the track is reduced in accordance that a moment arm of the camera about either rail of the track is short.

13. The system according to claim 12 wherein the dolly comprises:
a stanchion upon which is variably mounted and secured the camera so that a center of gravity of the camera is situated midway between the two spaced-parallel rails of the track.

14. The system according to claim 12 wherein the dolly comprises:
a motor for driving the dolly along the track.

15. A system for moving a camera in space along a straight line at fixedly predetermined elevational and azimuthal angles relative to this straight line, the system during all conditions of use to spatially move the camera comprising:
a track having two rails extending along an imaginary X axis direction which rails are straight to better than plus or minus one degree;
a plurality of members between the rails of the track along an imaginary Y axis which members hold the straight rails (i) at less than one percent deviation in distance of separation in the Y axis direction everywhere so that, at this distance of separation, (ii) the rails are everywhere spaced-parallel to within one degree;
a mechanism for adjusting the height above the surface of the earth of the track and its rails along an imaginary Z axis so that a plane of the rails is everywhere level to within one degree;
a dolly, having wheels both (i) fixed in separation at better than one percent accuracy wheel-to-wheel measured along the imaginary Y axis direction transversely across the track and (ii) of the same height to better than one percent, of both wheel-to-wheel separation and height so as to ride level within one degree of angle upon its equal-height wheels upon the evenly-spaced-parallel rails of the level track, the dolly mounting a camera at a fixedly predetermined position having less than one percent deviation in each of positions relative to the dolly along the imaginary X and Y axis directions, and having an elevation constant to within one percent along the imaginary Z axis direction, and having less than one degree variation in azimuthal and in elevational angles relative to the dolly;
wherein the dolly so mounts the camera at a moment arm in elevation relative to the track which moment arm is so short so that any variations relative to level of the dolly, which variations are themselves relative to any variation in level of the plane of the rails, produce less than one degree variation in both elevational and azimuthal angles of the camera relative to the straight line of the track.

16. The system according to claim 15 wherein the track comprises:
two spaced-parallel rails each rail having two upward-extending spaced-parallel lips; and
wherein the wheels of the dolly contact, and ride upon, only upward-extending spaced-parallel lips of the rails.

17. The system according to claim 16 wherein the track comprises:
a substantially planar elongate element shaped in the substantial contour of an external surface of one-half of an elongate prism, opposite side edges of the element transverse to its elongate axis constituting the upward-extending spaced-parallel lips.

18. The system according to claim 17 wherein the track's element comprises:
one-half of a tube, being a substantially planar elongate sheet shaped in the substantial contour of the external surface of one-half of an elongate cylinder.

19. The system according to claim 18 wherein the track's element comprises:
split aluminum tube.

20. The system according to claim 16 wherein the dolly's wheels comprise:
wheels of elastomeric compound spanning, and riding upon, opposite side edges of the element.

21. The system according to claim 16 wherein the dolly comprises:
a motor driving the dolly's wheels to propel the dolly along the track.

22. The system according to claim 16 wherein the track comprises:
track segments pieced together so that there is no appreciable crack nor any discontinuity in line and in level between abutting lips of successive segments.

23. A method of moving a camera in space comprising:
adjusting level above the surface of the earth a track having two spaced-parallel rails each rail having two upward-extending spaced-parallel lips; and
mounting a camera to a dolly riding upon both rails of the track, the dolly having wheels that contact only, and that ride upon, the upward-extending spaced-parallel lips of the rails.

24. The method according to claim 23 further comprising:
segmenting the track into track segments for transport and storage; while
piecing together the track segments during use for moving the camera in space so that two upward-extending spaced-parallel lips of one segment abut tightly and continuously to two upward-extending spaced-parallel lips of another segment, there being no appreciable crack nor any discontinuity in line and in level between abutting lips of successive segments.

25. The method according to claim 24 wherein the piecing together of the track segments comprises:
connecting track segments with and by members extending between, and connecting, adjacent track segments at, and between, a downward-extending region of each segment and of the track so that these connection members do not extend into the region of the upward-extending spaced-parallel lips of the segments and of the track.

26. The method according to claim 23 further comprising:
locating a center of gravity of the camera is within six inches of a plane between the lips of the two rails of the track;
wherein any sway in elevation angle of the camera during spatial movement of the camera along the track is reduced in accordance that a moment arm of the camera about either rail of the track is short.

27. The method according to claim 23 wherein the adjusting level of the track above the surface of the earth comprises:
adjusting the extension of a multiplicity of variably extending stanchions upon which supported the track above the surface of the earth.
